(19) United States
(12) Patent Application Publication
(10) Pub. No.: US 2018/0224856 A1
(43) Pub. Date: Aug. 9, 2018

(54) METHOD FOR MODIFYING AN ONBOARD CONTROL SYSTEM OF A POOL CLEANER, AND POWER SOURCE FOR A POOL CLEANER

(71) Applicant: AQUA PRODUCTS, INC., Cedar Grove, NJ (US)

(72) Inventors: Kameshwar Durvasula, Lyndhurst, NJ (US); Ethan Hanan, Teaneck, NJ (US); Vladimir Smagin, East Rutherford, NJ (US)

(21) Appl. No.: 15/928,445

(22) Filed: Mar. 22, 2018

Related U.S. Application Data
(63) Continuation-in-part of application No. 15/095,398, filed on Apr. 11, 2016.

(51) Int. Cl. G05D 1/02; E04H 4/16; G05D 1/00

(52) U.S. Cl. CPC G05D 1/0206; E04H 4/1654; G05D 1/0016; G05D 1/0022; G05D 2201/0203; B60Y 2306/15; B60Y 2400/301; B60Y 2410/115; B60Y 2400/604; B60Y 2400/214; B60Y 2200/40

(57) ABSTRACT

An onboard control system of an electrically powered pool cleaner (3) is disclosed. The disclosed system is configured to operate the pool cleaner in accordance with a setup (A, B, C) of the onboard control system (350). The pool cleaner is configured for receiving electrical power via a cable (2) connecting the pool cleaner (3) to a power source (1). A method for operating an automatic pool cleaner with segmented cleaning setup data is also disclosed and includes determining that the automatic pool cleaner is disposed in a particular segment of a pool based on outputs from one or more onboard sensors; and controlling movement of the automatic pool cleaner along a surface of the pool based on the determining so that the automatic pool cleaner spends a predetermined amount of time in the particular segment of the pool.

### CROSS-REFERENCE TO RELATED APPLICATIONS

This application claims benefit to and is a continuation-in-part of U.S. patent application Ser. No. 15/095,398, filed Apr. 11, 2016, and entitled “Method For Modifying An Onboard Control System Of A Pool Cleaner, And Power Source For A Pool Cleaner,” the disclosure of which is incorporated herein by reference in its entirety.

### TECHNICAL FIELD

The invention relates to the field of swimming pool cleaners, especially electrically powered robotic swimming pool cleaners arranged for movement on and cleaning of the surface of a swimming pool, including the bottom surface of the swimming pool and optionally wall surfaces of the swimming pool.

### BACKGROUND OF THE INVENTION

Electrically driven robotic swimming pool cleaners are well known in the art. Such cleaners generally include a power supply, typically an onboard battery and/or an external power source, often in the form of a portable power source device, placed in the vicinity of the swimming pool. When a power source external to the pool cleaner (such as a pool side power source or a floating power source) is used to power the pool cleaner, the power source is typically connected to the pool cleaner via a cable, for transmission of power and, in some cases, also of signals for controlling the pool cleaner.

This kind of pool cleaner typically comprises a pump for suctioning water and debris into the housing of the pool cleaner, a filter for trapping dirt and debris, and a drive motor and drive means such as wheels and/or tracks.

It is known in the art to provide pool cleaners with sensors that serve to determine the position and/or orientation of the pool cleaner, such as, for example, proximity to the vertical surfaces (the walls) of the swimming pool, inclination in relation to the horizontal plane (for example, tilt sensors), orientation in the horizontal plane (also known as directional orientation), accelerometers, gyroscopes, compasses, etc. Data obtained from the sensors is typically used to direct movement of the pool cleaner according to preset algorithms, that is, in a manner that is determined by a setup of the control system, such as an onboard control system. However, this setup may not always be optimal in view of the specific circumstances of a particular user, for example, in view of a specific shape and/or size of the swimming pool, in view of the characteristics of debris that is to be removed, the amounts thereof, etc. Thus, the user, such as an owner or operator of a swimming pool, may wish to modify the setup of the control system, for example, to minimize the time needed by the pool cleaner to complete a cleaning cycle, and/or to reduce the electrical energy needed for completing a cleaning cycle.

US-2015/0286194-A1 discloses a pool cleaner controlled by a control module placed outside the swimming pool. The control signals from the pool side control module as well as power for driving the pool cleaner are transmitted via a cable extending between the control module and the pool cleaner. It is described how this arrangement can be adapted for wireless control by a user, by inserting a modifying device into the link between the control module and the pool cleaner, whereby this modifying device is arranged for wireless communication with a remote device, such as a cellphone or a remote programmable device. This system makes it possible for a user to remotely control the pool cleaner using a cellphone, so that the user can cause the pool cleaner to operate in a manner differing from the manner defined by the setup of the original control system. However, remote control by the user himself or herself is time-consuming for the user and may indeed be suboptimal in terms of efficiency.

US-2014/0303810-A1 discloses a system for wireless communication with automatic pool cleaners, for example, for changing so-called navigation parameters. Communication takes place between a remote device—to which control software can be downloaded via the internet—and the swimming pool cleaner, via a wireless link. The system is focused on hydraulic cleaners, and the wireless link makes it possible to communicate with the swimming pool cleaner in spite of the lack of any wired connection. However, wireless communication with a swimming pool cleaner operating at the bottom of a swimming pool can sometimes be problematic, and US-2014/0303810-A1 does not explain how to deal with these problems.

US-2009/0057238-A1 discloses a swimming pool cleaner with a control system distributed between a caddy and a robot. Setup parameters can be introduced caddy-side and transmitted to the robot over the power cable, and the robot side control system will then operate according to the transmitted parameters.

EP-1122382-A1 discloses a pool cleaner that receives power from a power source floating in the swimming pool and that includes the control unit, for operating the pool cleaner in accordance with one or more cleaning programs or in accordance with control signals transmitted by an operator through radio signals from a hand-held control set.

### GENERAL DESCRIPTION OF THE INVENTION

It has been found that there is a need for easy and flexible updating of the setup of the control systems of pool cleaners, for example, to enhance the operational efficiency of the pool cleaners. In some instances, the operational efficiency is enhanced by incorporating new operation related means, such as new programs or algorithms developed at the manufacturer's end or at a third party's end. In other instances, a user (such as a swimming pool owner, operator, or other interested party) may improve the operation of the pool cleaner by adapting software, such as programs or operation parameters, to pool-specific conditions, such as to a specific swimming pool type (in terms of for example shape and/or dimensions of the swimming pool), etc. It has also been found that it can be advantageous to allow this kind of updating, adaptation or other kind of modification to be carried out without any need for the person or party in charge to rely on or verify that the pool cleaner as such is available or “on-line” or to directly manipulate the pool cleaner as such.

It is an object of this invention to provide a method for modifying the setup of an onboard control system of a swimming pool cleaner.

A further object of this invention is to provide a method for pre-setting the behavior of the pool cleaner.

A further object of the invention is to enable pre-setting the pool cleaner's response to data read from onboard sensors.

A further object of the invention is to enable presetting of fixed behavior algorithms in the pool cleaner.

A further object of the invention is to enable customization of the pool cleaner's behavior to the characteristics of the swimming pool.

A further object of the invention is to enable presetting of the pool cleaner's behavior parameters based on pool characteristics uploaded by the end user into a computer network system.

A further object of the invention is to enable downloading of pool cleaner behavior parameters from a data network and programming the parameters in an onboard control system of the pool cleaner.

A further object of the invention is to enable communication of pool cleaner health and operation status to a user via a remote computing device.

A further object of the invention is to enable pre-selection of pool cleaner operation characteristics while the pool cleaner is disconnected or in an inoperative or “off” state, and uploading corresponding operation parameters to the pool cleaner when the pool cleaner is connected or put into an operative or “on” state at a later point of time.

A first aspect of the invention relates to a method for modifying a setup of an onboard control system of an automatic pool cleaner, that is, a swimming pool cleaner that comprises an onboard control system that determines the operation of the pool cleaner. The onboard control system is configured to, or adapted to, such as programmed to, operate the pool cleaner in accordance with the setup of the onboard control system. The setup is determined by software, such as one or more parameters and/or programs stored in at least one on-board memory of the pool cleaner, and the setup determines the operation of the swimming pool cleaner, for example, in terms of one or more basic movement patterns and/or in terms of reactions to output from sensors. In some embodiments, the pool cleaner is an electrically powered pool cleaner configured for receiving electrical power via a cable connecting the pool cleaner to a power source. That is, the pool cleaner may be connected, via a cable, to a power source comprising an external (or remote) power supply for the pool cleaner, for example, a power source device—such as a portable power source device or apparatus—arranged outside the swimming pool or in the water of the swimming pool, such as floating in the water, so that power can be transmitted from the power source to the pool cleaner through a dedicated cable. The power source includes some kind of power supply means, mechanism, device, or module, for example, the power supply means may be connected to some kind of power supply grid, such as to the general electrical network or to a local electrical network, and adapted to supply electrical power to the pool cleaner via the cable. Alternatively, the pool cleaner may include a battery system (and, thus, need not be connected to a power supply via a cable).

One method in accordance with the present invention may comprise:

providing setup data to the power source, the setup data including, for example, one or more programs, algorithms, parameters, etc., and

modifying the setup of the onboard control system from the power source via the cable, based on the setup data, for example, by forwarding the setup data to the onboard control system of the pool cleaner, or by forwarding data or other signals derived from the setup data and/or corresponding to the setup data. In some embodiments, the power source can be more involved with the modification/reprogramming of the onboard control system than in other embodiments. For example, in some embodiments there can be a master-slave relationship in which a substantial part of reprogramming is carried out under the control and/or supervision of the power source, whereas in other embodiments the reprogramming is substantially carried out by the pool cleaner itself, in response to (such as triggered by) signals and/or data received from the power source via the cable. For example, in some embodiments, the power source forwards modification data to the pool cleaner via the cable, the modification data being based on the setup data. For example, the modification data may comprise the setup data or part thereof, or the modification data may be derived from the setup data in another way. The modification data can, for example, comprise commands, programs or parts of programs, parameters, etc. In some embodiments, these commands, programs, parts of programs and/or parameters may be part of the setup data or they may even constitute the setup data, and in other embodiments they are derived from the setup data in other ways, such as by conversion tables or similar.

This arrangement has been found to be advantageous in that, for example, the power source may often be more readily available for communication with an external device or system than the swimming pool cleaner, which may often be turned off, disconnected from the power source, and/or placed in water and unable to directly receive, for example, wirelessly transmitted data. The external device can be, for example, a terminal or other kind of device connected or connectable to the internet, to a local network or to any other kind of source for communication, or to any other kind of device capable of providing the setup data. The power source including the power supply from which power is supplied to the pool cleaner via the cable can easily be arranged to be, for example, continuously or almost continuously ready to receive data transmitted to it from the external device, for example, over a wireless link or via any other suitable link, such as, for example, via connection to an external device via a USB port or any other kind of wired link. The power source can then trigger the modification of the setup of the control system of the pool cleaner the next time the pool cleaner is set into a mode that allows the modification of the setup of the control system, for example, the next time the pool cleaner is turned on and/or connected to the power source via the cable, and/or in response to a trigger action carried out by the user, for example, by pushing a button, entering a code using a keyboard or similar, or operating on any other activation means.

One advantage of the present invention is that there is no pre-established link between the availability of the power source and the availability of the pool cleaner, in terms of the availability to receive data from an external device or system such as a user terminal. The availability of the pool cleaner can depend on many circumstances related to its use, for example, use in different swimming pools, maintenance operations, etc. The power source can often be available for receiving setup data even when the pool cleaner as such is not available. Thereby, at least a first part of a process of modifying the setup of the onboard control system of a pool cleaner can be carried out without the pool cleaner as such being available, by transferring the relevant setup data to the power source and, if necessary, by storing the setup data there. The modification process can then be completed once the pool cleaner becomes available, and/or following a trigger action by the user, whereby the user authorizes or triggers completion of the process.

In some embodiments of the invention, the pool cleaner comprises a housing, drive means or a drive mechanism including wheels and/or tracks, at least one electrically driven motor, at least one pump for pumping water from at least one inlet to at least one outlet through at least one filter for retaining debris. In some embodiments, the onboard control system, the motor, the pump and the filter are arranged within the housing. In some embodiments, the same motor is used for driving the pump and the drive means. In other embodiments, different motors are used for driving drive means or drive mechanism and the pump.

In some embodiments, the onboard control system is operatively connected to at least one orientation and/or position sensor. The sensor can be selected from a list including magnetometers, accelerometers, angular rate sensors, tilt sensors, proximity sensors, motion sensors, or any combination thereof.

In some embodiments, for the purpose of determining the orientation of the pool cleaner, an accelerometer is used to measure tilt angle about three axes.

In some embodiments, the pool cleaner comprises an angular rate sensor, commonly known as a gyro. Based on the output from such a sensor, the onboard control system can, by integrating the rate and elapsed time, compute an estimate of the orientation and/or position of the pool cleaner.

In some embodiments, the pool cleaner includes at least one proximity sensor, the output of which can be used by the onboard control system to determine the proximity of the pool cleaner to a substantially vertical surface of the pool.

In some embodiments, the pool cleaner comprises an accelerometer or tilt sensor, the output of which can be used by the onboard control system to determine the pool cleaner's orientation about a pitch, yaw and/or roll axis.

In some embodiments, the pool cleaner comprises a magnetometer, commonly known as an electronic compass, the output of which can be used by the onboard control system to determine the orientation of the pool cleaner.

For example, when the pool cleaner in accordance with some embodiments is moving over a substantially horizontal surface, the onboard control system can compute the inclination of the surface on the basis of data read from the tilt sensor or accelerometer, which is commonly configured to provide information about the tilt angle. The onboard control system can also determine when the pool cleaner has translated from a substantially horizontal movement on the pool floor to a substantially vertical movement on a pool wall, based on significant changes in angle read from the tilt sensor or accelerometer, changes in torque measured on the motor, data read from a proximity sensor, or any combination thereof.

In some embodiments, by comparing an angle to the horizontal plane read from the tilt sensor when the pool cleaner translates from vertical to horizontal movement, the onboard control system can determine whether the pool cleaner is at the deeper or shallower end of the pool, as the angle between floor and wall is different at the shallower end than at the deeper end. Similarly, the onboard control system can determine whether the pool cleaner is moving between a shallow section (e.g., a shallow end) and a sloped section or whether the pool cleaner is moving between the sloped section and a deep section (e.g., a deep end). The onboard control system can retain, in a memory thereof, an indication of whether the pool cleaner is at the shallow end or at the deep end of the pool. The user can, for example, preselect whether the pool cleaner should adapt its movement to spend more time cleaning the deep end or the shallow end of the pool, and upload the corresponding data to the pool cleaner, using the method described above. If the user preselects that the pool cleaner should spend time in a certain end or section of the pool (e.g., the deep end or the shallow end), the onboard control system may implement a segmented pool cleaning program described herein.

Conventionally, robotic pool cleaners are typically programmed to perform most efficiently in square or rectangular pools. As such, they are typically pre-programmed to turn at right angles to a previous heading and continue a path which is perpendicular the original track. However, in a non-rectangular pool such as a round, oval or irregularly shaped pool, this may not be the optimal strategy in order to cover the pool surface in a minimum amount of time and/or using a minimum amount of energy.

Now, as explained above, a pool cleaner can compute the angle by which it turns by reading data from an angular rate sensor, magnetometer, or combination thereof, and perform a turn at any preset angle. Furthermore, the time of travel between turns can be preselected, to provide optimal performance according to the dimensions and/or shape of the pool.

In accordance with some embodiments of the invention, the pool cleaner is in communication with a power source which is positioned outside the pool (i.e. a remote power source), such as within a couple of meters from the pool edge; for example, in some countries the applicable regulations establish a minimum distance between a device directly fed by the mains and the edge of the swimming pool, for example 3.6 meters. The power source is connected to the pool cleaner by a cable which can supply power and data. In some embodiments, data is communicated by a separate wire or pair of wires in the cable. In some embodiments, data transmission takes place by modulating a signal on the power wires, that is, using so-called power line communication. The power source itself is, in some embodiments of the invention, in communication with a user terminal, for example, a handheld device such as a smartphone, a tablet, a laptop, or any other kind of computer device. The communication between the power source and the user terminal may be wireless, using for example a protocol such as wifi or Bluetooth, or any other suitable protocol. Alternatively, the communication between the power source and the user terminal may be wired, using a protocol such as USB or any other suitable protocol.

In some embodiments of the invention, the user terminal may be connected to the internet with access to data uploaded by the user or by another entity. The user terminal device may alternatively be programmed by the user and store data in its own memory.

In some embodiments, the user can access a computer program incorporating a graphical user interface, and select parameters based on the pool in which the pool cleaner will operate. For example, the user can specify the minimum and maximum depth of the pool, pool shape, dimensions such as length and width, options regarding the most relevant debris found in the pool (leaves, sand, etc) and/or preferred pool cleaner operation time. Based on for example this kind of data input by the user, the program can then select the optimum parameters for pool cleaner operation, including, but not limited to, angle of turn, percentage of cycle time spent at the deeper or shallower end of the pool, time between turns, and/or time on the pool wall. The user terminal can then transmit the relevant parameters to the power source, where these parameters can be stored in a memory such as a non-volatile memory. The power source may then transmit the setup data comprising the parameters (or other modification data based on, such as derived from, the setup data) to the pool cleaner almost instantaneously, or alternatively retain the setup data in the memory and transmit the setup data (or other modification data based on the setup data) to the pool cleaner the next time the pool cleaner is powered on, or the next time a cleaning cycle is initiated, or in response to a trigger action performed by the user. The power source will transmit the relevant data, such as parameters, to the pool cleaner via the power/data cable.

In some embodiments, the pool cleaner may be configured to transmit information regarding its operation, as detected by its sensors, to the power source. The data transmitted may include indications of errors in the operation of the pool cleaner, and the data may then be transmitted by the power source to an external device, such as to the user terminal, for example, to be displayed to the user. The power source and/or the user terminal may be configured to signal discrepancies between the operation of the pool cleaner and the selected parameters, and may suggest selection of alternative parameters. For example, the pool cleaner may detect that the gyro sensor does not register complete turns when the control system operates the pool cleaner to carry out a complete turn, and the user may then be prompted to select a longer operating time.

In some embodiments, an optional command can be provided by means of which the user can select whether the setup data will be retained in the memory of the power source. For example, a user may wish to maintain different sets of setup data corresponding to different setups of the control system, in the memory of the power source, and upload a selected set of setup data to the pool cleaner when desired. For example, some operators may own two or more swimming pools (for example, a larger and deeper pool for adults and a smaller and shallower pool for children) and may desire to adapt the setup of the pool cleaner in accordance with the pool to be cleaned at any given moment. For this purpose, data corresponding to two or more alternative setups can be stored in the memory of the power source and then be used to modify the setup of the pool cleaner whenever desired, for example, in response to an instruction from the user.

The user terminal can, in some embodiments, be configured to access the internet and accept updated program files for operation of the pool cleaner. Typically, these updates may comprise improved algorithms to include further features or to resolve problems. These files can be used as setup data to modify the setup of the control system of the pool cleaner, as explained above. For example, when the pool cleaner is turned on, the power source may begin a sequence of operations in which a command to accept an updated program is sent to the pool cleaner, and the program itself is uploaded to the onboard control system via the cable.

In some embodiments of the invention, and after receiving the setup data, the power source selectively:
triggers modification of the setup of the onboard control system of the pool cleaner if the pool cleaner is available for receiving corresponding data (for example, the setup data themselves or data derived therefrom) via the cable; or
stores the setup data in a memory of the power source if the pool cleaner is not available for receiving the corresponding data via the cable, and subsequently triggers modification of the setup of the onboard control system of the pool cleaner based on the stored setup data, when the pool cleaner becomes available for receiving the corresponding data via the cable. Frequently, pool cleaners are powered off or otherwise disconnected from the power source, for example, during storage, maintenance, etc. In many embodiments of the invention, the power source can be configured to trigger modification of the setup of the control system when receiving the corresponding data, for example, immediately or almost immediately after receiving them, if the pool cleaner is “available.” If the pool cleaner is not available, the setup data—in some embodiments, modification data derived therefrom—can be stored in the power source, such as in a non-volatile memory thereof, and then be used to trigger modification of the setup of the control system of the pool cleaner once the pool cleaner becomes available, for example, once the cable thereof is plugged into the power source and/or once the pool cleaner is turned into an “on” state. Thereby, the user or other party who desires to update or otherwise modify the setup of the control system can do so, independently of whether the pool cleaner is available or not. If the pool cleaner is not available, the relevant setup data will be stored in the power source and used to modify the setup of the control system at later stage. However, the user will not have to reinitiate the process, that is, once the user has carried out his or her part of the task operating on his or her terminal, the rest of the process can be transparent to the user, as it is carried out between the power source and the pool cleaner. However, in some embodiments, the user can receive, for example, at his or her terminal, a confirmation message or similar once the modification of the setup of the control system has been completed. Also, in some embodiments, completion of the operation may require an additional confirmation or trigger action by the user, such as the selection of an “upload now” mode.

The expression “trigger modification” is intended to encompass any action of modification of the onboard control system that is initiated from the power source, and includes the forwarding of modification data including or derived from the setup data, from the power source to the pool cleaner, via the cable.

In some embodiments of the invention, the setup data are stored in a memory of the power source, and the step of modifying the setup of the onboard control system is carried out in response to a trigger action carried out by a user, for example, a trigger action comprising pushing a button, keying a code, sending a trigger command from an external device, etc. Thus, a user can upload the setup data to the power source, but postpone completion of the process of modifying the setup of the onboard control system until a later stage. For example, a user can upload an “autumn weather cleaning program” or “autumn weather cleaning parameters” to the power source, but postpone the actual change of the setup of the onboard control system of the pool cleaner until the autumn arrives and leaves start to accumulate in the swimming pool.

In some embodiments of the invention, the step of providing setup data to the power source comprises selecting operating parameters using an interface program running on a terminal external to the power source. Thereby, a user, such as the person in charge of the pool cleaning, can use the interface program and select operating parameters for the pool cleaner interacting with the interface program, based on characteristics of the pool such as dimensions, shape, etc., or based on other conditions affecting the cleaning such as expected kind and/or quantity of debris, and thereby obtain setup data comprising operating parameters potentially appropriate for efficient pool cleaning under the relevant conditions. For example, the parameters can be obtained from an entity such as the manufacturer or supplier of the pool cleaner, or from a related entity, via the internet or via another appropriate link. The user can carry out these operations using any suitable terminal, such as a smartphone, tablet, laptop, or other kind of computing device. The setup data can then be uploaded to the power source using any suitable link, such as a wireless link, a wired link, a memory stick, etc.

In some embodiments of the invention, the power source includes means for wireless communication, and the step of providing setup data to the power source comprises providing the setup data to the power source over a wireless link, via the means for wireless communication. That is, the user can, for example, obtain the relevant setup data/parameters using a terminal connected to, for example, the internet or any other suitable link or network, and forward the setup data to the power source in a wireless manner, for example, via Bluetooth or any other suitable wireless link.

In some embodiments of the invention, the step of providing setup data to the power source comprises providing the setup data to the power source over a wired link, for example, using a USB port or any other suitable means. That is, the user can obtain the setup data on a terminal such as a smartphone, tablet, laptop or other terminal, and transfer the setup data to the power source using the wired link, for example, a memory stick or any other suitable device.

In some embodiments of the invention, the method comprises the steps of storing at least two alternative sets of setup data in the memory of the power source, selecting one of the stored sets of setup data, and modifying the setup of the onboard control system on the basis of the selected set of setup data. That is, a user can for example store, in the memory of the power source, a library comprising different sets of setup data, and use them to selectively modify the setup of the onboard control system, so as to achieve a desired behavior of the pool cleaner, for example, in view of specific conditions, such as weather conditions, pool size and/or shape, etc.

In some embodiments of the invention, the setup data are stored in a memory, preferably a non-volatile memory, of the power source. That is, the power source can store the setup data, so that they are available at the power source when the pool cleaner becomes available for receiving the setup data (or the modification data based thereon, such as modification data derived from the setup data), for example, when the pool cleaner is powered on and/or plugged into the power source.

In some embodiments of the invention, the onboard control system is arranged to operate the pool cleaner based on data obtained from a plurality of onboard sensors of the pool cleaner, whereby the setup of the onboard control system determines at least in part the operation of the pool cleaner in response to the data obtained from the plurality of onboard sensors. That is, the response of the swimming pool cleaner to sensor output signals indicative of, for example, distance to vertical sides of the swimming pool, tilt angle, orientation in the horizontal plane, clogging of the filter, etc., is determined by the setup, and can thus be modified by modifying the setup using the method described above. As a specific example, in some scenarios (e.g., based on instructions from a user to focus on the shallow end and/or deep end), the onboard control system controls the swimming pool cleaner in accordance with a segmented pool cleaning program that utilizes sensor data indicative of the pool cleaner's location in a particular segment (e.g., deep end, shallow end, or a sloped section therebetween) to determine if the pool cleaner is in or is leaving a particular section or segment of the pool.

In some embodiments of the invention, the onboard control system is arranged to operate the pool cleaner in accordance with commands stored in the onboard control system, whereby the step of modifying the setup of the onboard control system comprises modifying, such as replacing, one or more of the commands. In some embodiments, the commands determine an intended path to be followed by the pool cleaner during its movement on the surface of the swimming pool, such as on the surface of the bottom and/or the walls of the swimming pools. The reference to modification of commands includes actions such as altering the sequence of commands.

A further aspect of the invention relates to a power source, such as a pool side power source or a power source floating in the swimming pool, for a pool cleaner, comprising:

a power supply or means for supplying electrical power to a pool cleaner via a cable;

a memory, for example, a non-volatile memory, for storing setup data for an onboard control system of a pool cleaner;

a receiver or first data communication means for receiving the setup data from an external device, such as a user terminal; and

a communication module or second data communication means for communication with the onboard control system of the pool cleaner, via the cable.

The power source is configured for triggering modification of a setup of the onboard control system of the pool cleaner on the basis of the stored setup data, for example, by forwarding the setup data or related data, such as derived data, to the onboard control system.

What has been explained above in relation to the method also applies to the power source, mutatis mutandis.

As explained above, the expression “trigger modification” encompasses any action that results in the modification of the setup of the onboard control system, based on the transmission, from the power source to the pool cleaner, via the cable, of modification data such as parameters, commands, programs or parts thereof, comprising the setup data or data based on the setup data, such as derived therefrom.

In some embodiments, the power source is configured, such as programmed, to store setup data for the onboard control system of the pool cleaner in the memory, and to subsequently (that is, at a later stage) trigger modification of the setup of the onboard control system of the pool cleaner, based on the setup data. In some embodiments, the power source is configured, such as programmed, to trigger modification of the setup of the onboard control system based on the setup data, when the pool cleaner becomes available for receiving corresponding data via the cable. As explained above, frequently, pool cleaners are powered off or otherwise disconnected from the power source, for example, during storage, maintenance, etc. In many embodiments of the invention, the power source can be configured to trigger modification of the setup of the control system when receiving the corresponding data, for example, immediately or almost immediately after receiving them, if the pool cleaner is “available”. If the pool cleaner is not available, the setup data can be stored in the power source, such as in a non-volatile memory thereof, and then be used to modify the setup of the control system of the pool cleaner—for example, by transferring the setup data or other data derived from the setup data—once the pool cleaner becomes available, for example, once the cable thereof is plugged into the power source and/or once the pool cleaner is turned into an “on” state. Thereby, the user or other party who desires to update or otherwise modify the setup of the onboard control system can do so, independently of whether the pool cleaner is available or not. If the pool cleaner is not available, the relevant setup data will be stored in the power source and used to modify the setup of the control system at later stage. However, the user will not have to reinitiate the process, that is, once the user has carried out his or her part of the task operating on his or her terminal, the rest of the process can be transparent to the user, as it can be carried out between the power source and the pool cleaner. In some embodiments, the power source is configured to trigger modification of the setup of the onboard control system based on the setup data following a trigger action carried out by a user. The trigger action can comprise, for example, pushing a button, entering a code, sending a trigger command from an external device, etc.

A further aspect of the invention relates to a system comprising a power source as described above, and a pool cleaner with an onboard control system, the pool cleaner being configured for, such as programmed for, modification of the onboard control system by receiving signals over a cable interconnecting the power source and the pool cleaner, for example, based on setup data stored in a memory of the power source.

### BRIEF DESCRIPTION OF THE DRAWINGS

The drawings referenced below simply serve as examples of how the invention can be carried out, by illustrating embodiments of the invention, and should not be interpreted as restricting the scope of the invention.

FIG. 1 is a schematic perspective view of a system in accordance with an embodiment of the invention implemented in correspondence with a swimming pool.

FIG. 2 is a perspective view of a pool cleaner in accordance with an embodiment of the invention.

FIG. 3 schematically illustrates the control system integrated in a pool cleaner in accordance with an embodiment of the invention.

FIG. 4 schematically illustrates the interaction between different components of a system, in accordance with an embodiment of the invention.

FIG. 5 schematically illustrates some components of the power supply in accordance with an embodiment of the invention.

FIG. 6 is a flowchart showing operation in accordance with an embodiment of the invention.

FIG. 7 is a flowchart showing operations of the onboard control system when implementing a particular set of setup data, in accordance with an embodiment of the invention.

Like reference numerals have been used to identify like elements throughout this disclosure.

### DETAILED DESCRIPTION OF A WAY OF CARRYING OUT THE INVENTION

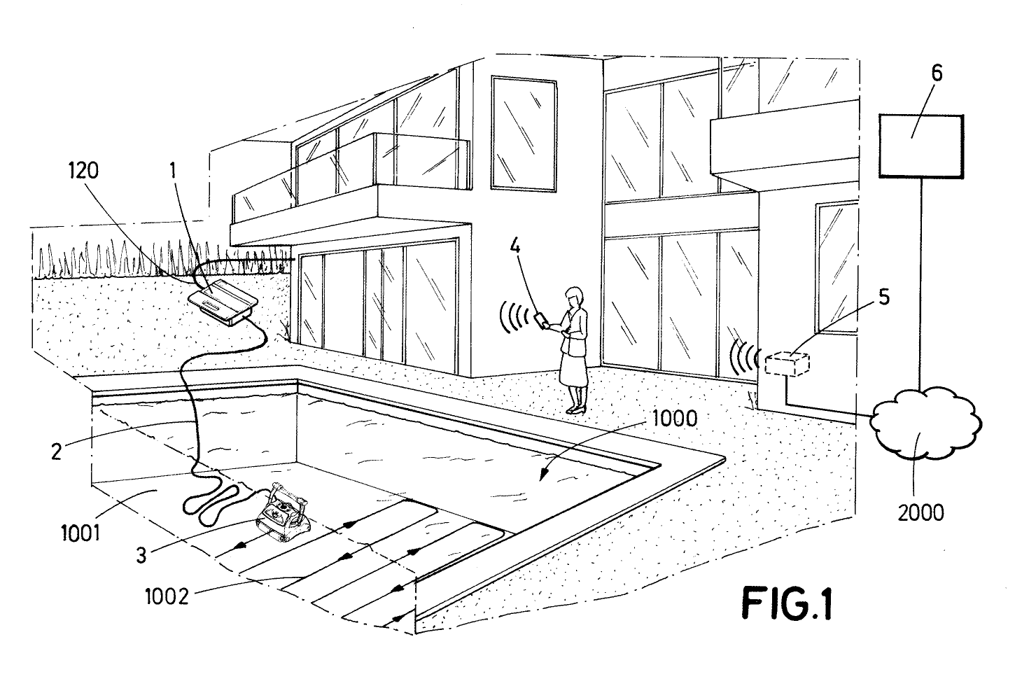

FIG. 1 illustrates a pool cleaner 3 moving on the bottom surface 1001 of a swimming pool 1000, following a path 1002. The pool cleaner receives electrical power from a remote power source 1 via a power cable 2. The power source 1 is, in this embodiment, a pool side power source placed a couple of meters from the edge of the swimming pool, and connected to an external power grid via a cable 120. That is, the power source 1 is connected to the pool cleaner 3 by one cable 2 and to the power grid by another cable 120. The power source 1 comprises, in the illustrated embodiment, a communication module or means for wireless communication with a user terminal 4 such as smartphone or tablet computer. The user terminal 4 is provided with its own a communication module or means for wireless communication with a local communication node 5, through which the terminal 4 can establish communication with a remote computer or computer system 6, over a network 2000.

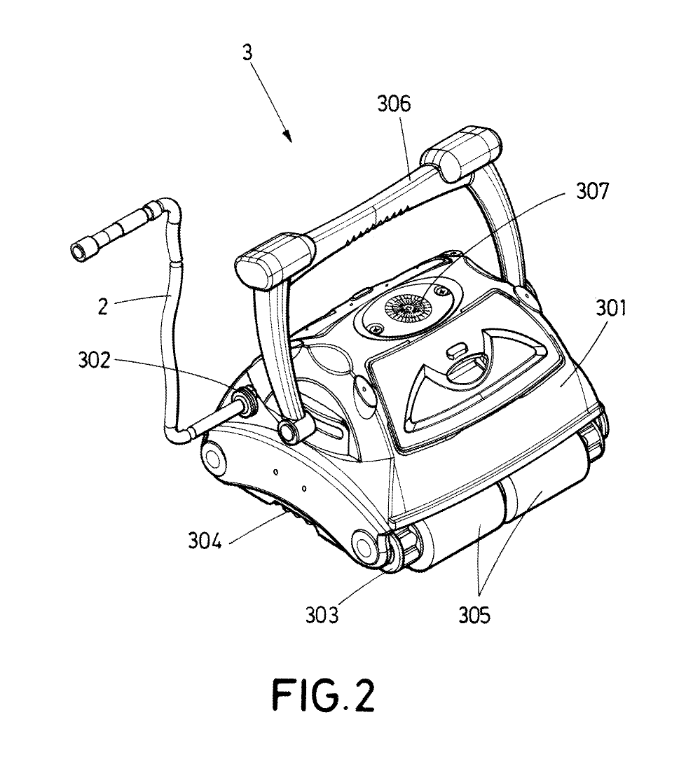

FIG. 2 shows how, in this embodiment, the pool cleaner 3 may comprise a housing 301, a connection 302 for receiving the power cable 2, drive wheels 303 and track 304 for moving pool cleaner 3, a brush 305 for uses known in the art, a handle 306 for uses known in the art, and a pump outlet 307 for a pump unit. Water is typically sucked in through inlets arranged in correspondence with the bottom of the housing 301 of pool cleaner 3, so that it passes through at least one filter wall of a filter assembly arranged within the pool cleaner 3, before exiting through the outlet 307, so that debris is retained within the pool cleaner 3, by the filter.

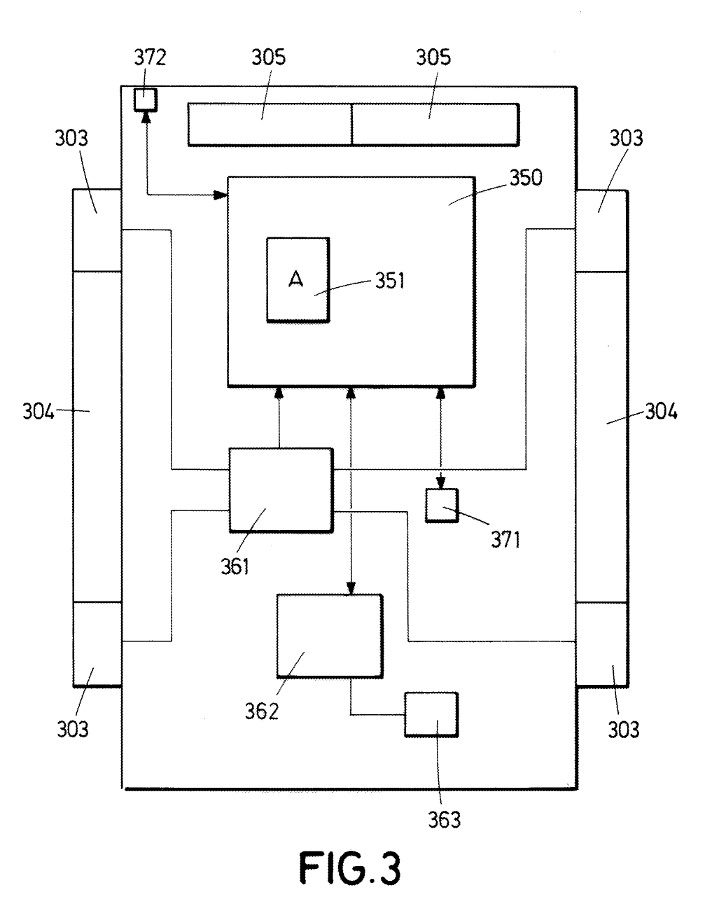

FIG. 3 schematically illustrates how the pool cleaner 3 may comprise an onboard control system 350 arranged to interact with different components of the pool cleaner so as to operate the pool cleaner in accordance with a setup of the onboard control system, the setup being schematically illustrated by a set of setup data A loaded in a memory 351 of the onboard control system 350. The onboard control system 350 is operatively connected to a drive motor 361 for driving the wheels 303 and track 304 and, in some embodiments, also the brush 305. The onboard control system 350 is further operatively connected to a motor 362 for driving the pump 363. In some embodiments, one and the same motor is used for driving both the wheels 303 and tracks 304 and/or other means for displacing the robot and for driving the pump 363. In other embodiments, different motors are used. The onboard control system 350 operates the motors 361 and 362 in accordance with the setup of the onboard control system, that is, in accordance with the software A loaded in the onboard control system.

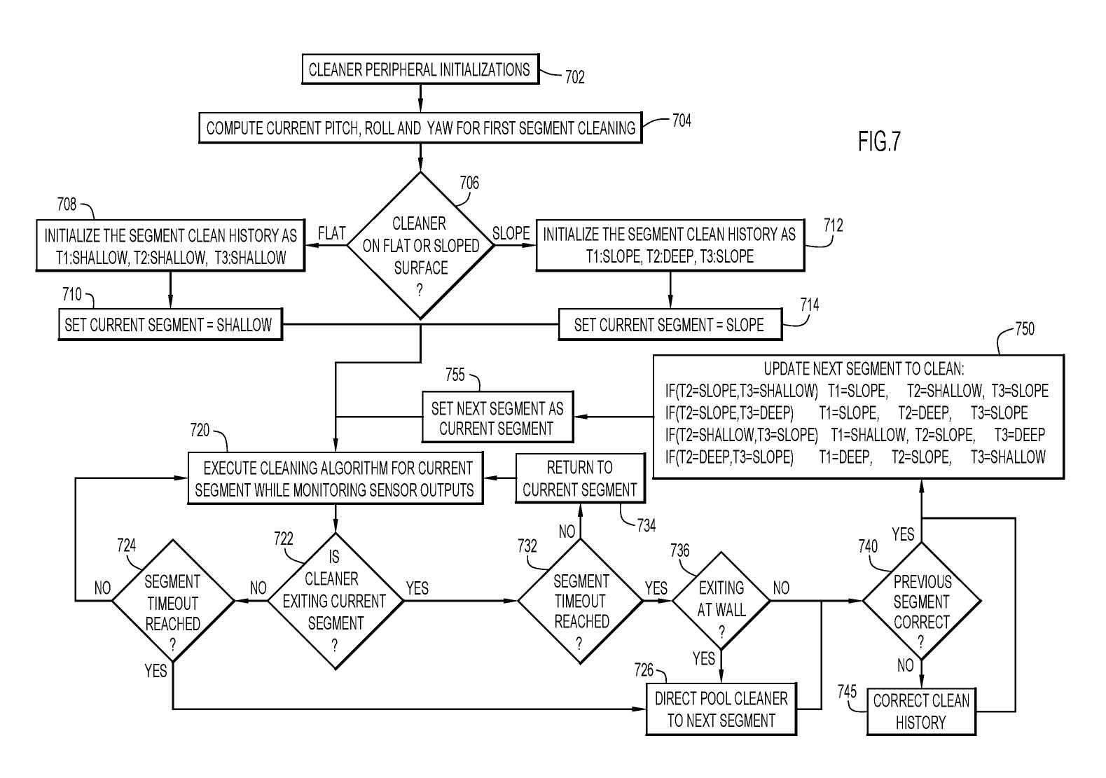

In the illustrated embodiment, the pool cleaner also includes sensors, such as a tilt sensor 371 and a proximity sensor 372, which are connected to the onboard control system 350 to allow the onboard control system to read sensor data from the sensors. The reaction of the pool cleaner 3 in response to the output from the sensors, for example, in terms of operation of one or both motors 361 and 362, and/or in terms of operation of one or both tracks 304, may depend on the setup of the onboard control system 350. For example, motors 361 and 362 may operate to cause the pool cleaner 3 to remain in (or exit from) a certain segment of a pool if the onboard control system is operating in accordance with setup data from a segmented pool cleaning program, as is described in further detail below in connection with FIG. 7.

Thus, the setup of the onboard control system 350 can determine aspects such as duration of a cleaning cycle, frequency of cleaning cycle, and operation of the drive means or motors, for example, in order to follow a given path and/or in terms of the reaction to sensor output such as, for example, detection of proximity to a vertical wall, etc. Additionally, the onboard control system 350 can determine a location of the pool cleaner 3 within a pool based on sensor output, such as tilt sensor and proximity sensor output.

Further examples of sensors that may be incorporated into the pool cleaner 3 include a sensor that detects clogging of filter walls by sensing operational parameters of the motor 362 driving the pump. The setup of the onboard control system 350 can determine, for example, whether to perform a backwash operation in response to sensed operational parameters of the motor 362 such as measured torque. In another setup of the onboard control system 350, backwash can be carried out with a predetermined frequency, independently of how the pump motor 362 operates.

A given setup of the pool cleaner 3 may be considered preferred under certain circumstances, for example, given a certain swimming pool size or type, given a certain time of the year, etc. Thus, sometimes a user may wish to modify the setup, for example, to increase the frequency and/or duration of the cleaning cycles carried out by the pool cleaner 3. A user may also wish to modify the setup to focus the pool cleaner 3 on a particular section of a pool.

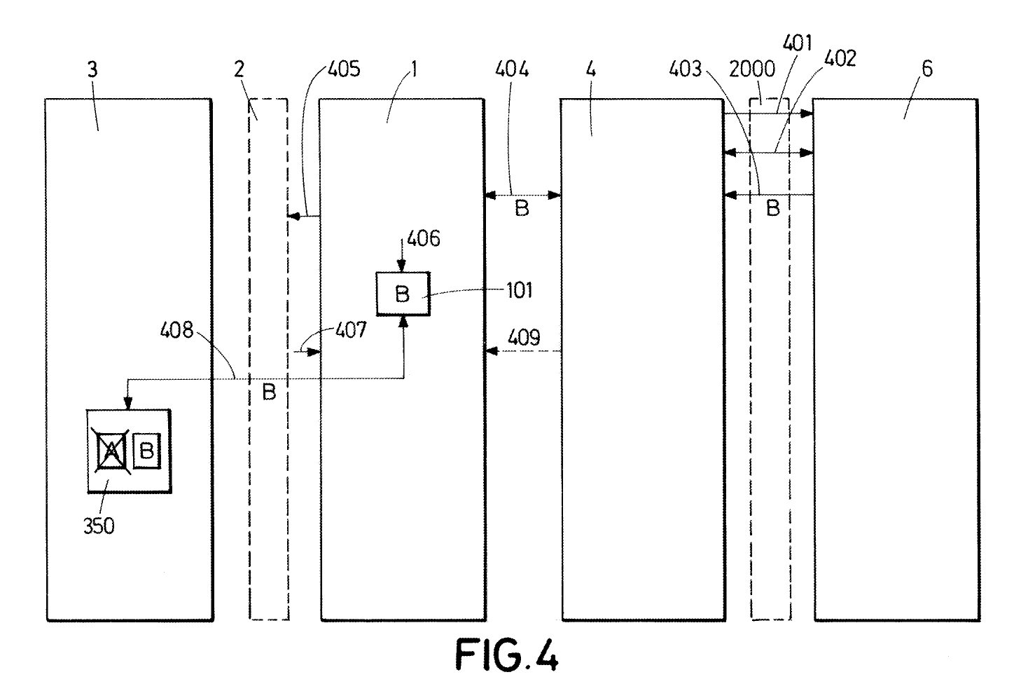

FIG. 4 shows how a user, from a user terminal 4, establishes 401 a session accessing an external computer system 6 over a network 2000 such as the internet. The user can, for example, accesses a computer program incorporating a graphical user interface, and select parameters based on the pool in which the pool cleaner 3 will operate. A session 402 is established between the user and the external computer system 6, whereby the user, using for example a graphical interface program, selects certain parameters, and receives pool cleaner control system setup data B from the external computer system 6. For example, the user can provide parameters such as size and shape of a swimming pool to a computer system 6 related to the manufacturer or supplier of the pool cleaner 3, and receive 403 setup data B that, when loaded into the onboard control system 350 of the pool cleaner 3, causes the pool cleaner 3 to operate in a manner considered appropriate for a swimming pool featuring these parameters. For example, the setup data B may cause the pool cleaner 3 to clean the pool in a sectional or segmented manner, as is explained in detail below in connection with FIG. 7.

Next, a session 404 of communication is established between the user terminal 4 and the power source 1. Here, the setup data B are forwarded from the user terminal 4 to the power source 1, together with instructions to upload the setup data B to the pool cleaner 3.

In the following step, the power source attempts 405 to establish a session with the pool cleaner 3, but detects that the pool cleaner 3 is not available, for example, because it is turned off or because the cable 2 is not connected to the power source 1 (for example, because the pool cleaner 3 is stored somewhere else, in use in another swimming pool, etc.). The power source 1 then stores 406 the setup data B in an internal memory 101 of the power source 1.

When the power source 1 detects 407 that the pool cleaner 3 is available for receiving the setup data, a session 408 is established between the power source 1 and the pool cleaner 3, whereby the setup data B are transferred from the memory 101 of the power source 1 to the onboard control system 350 of the pool cleaner 3, via the power cable 2, for example, replacing previous setup data A and thereby modifying the way in which the pool cleaner 3 will operate.

In some embodiments, the power source 1 does not initiate steps 405 or 408 before receiving instructions 409 from the user terminal 4 indicating that the setup data B are to be transferred to the pool cleaner 3. That is, in some embodiments, setup data B are stored in the memory 101 of the power source 1, until the user triggers 409 transfer to the pool cleaner 3.

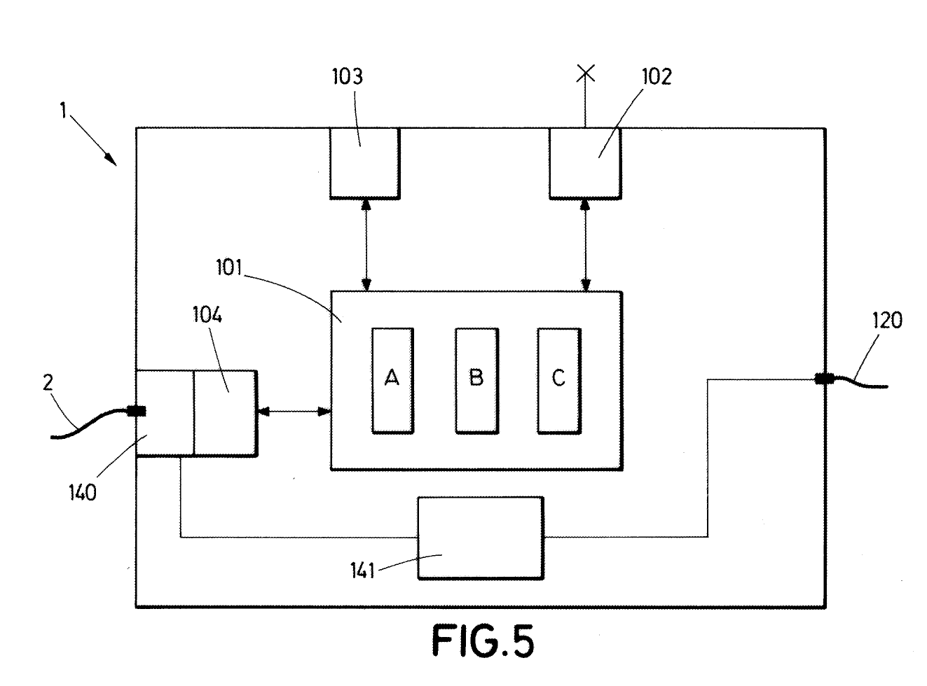

FIG. 5 schematically illustrates the layout of a power source 1 in accordance with an embodiment of the invention. The power source 1 is connectable to an electrical network (not shown, but typically the general power supply grid) via a cable 120. Cable 120 connects the electrical network to internal power supply 141 of the power source 1, which is connectable to the power supply cable 2 of the pool cleaner 3 via a power interface 140. So far, the power source 1 can be constituted substantially as a conventional power source of the type that is used to supply power to a pool cleaner while receiving power from the power grid.

However, in this embodiment of the invention, the power source 1 further includes means for wireless communication or wireless communications module 102 (for example, adapted for communication according to a protocol such as wifi or Bluetooth) and means for wired communication or wired communication device 103 (such as a USB port). Thereby, communication with a user terminal 4 is possible, allowing the user to forward the setup data B to the power source 1, to be forwarded to the pool cleaner 3 or stored in the memory 101 of the power source 1. From this memory 101, the setup data can be uploaded to the pool cleaner 3 via the cable 2, via a communication interface 104 operatively connected with the power interface 140.

FIG. 5 schematically illustrates how a plurality of sets of setup data A, B and C are stored in the memory 101 of the power source 1. This is so in accordance with an embodiment, in which a user can obtain different sets of setup data and store them in the memory 101 of the power source 1. Thereafter, whenever desired, for example, depending on the weather, the time of the year, the kind of swimming pool to be cleaned, etc., the user can upload a selected one of said sets of setup data to the pool cleaner 3, thereby modifying the way in which it will operate.

In some embodiments of the invention, the user can choose between an immediate update option, in which the new setup data are uploaded directly to the pool cleaner 3, if it is available for such an upload, and a delayed update option, in which the setup data are stored in the memory 101 of the power source 1 until a trigger action is performed by the user, triggering the upload.

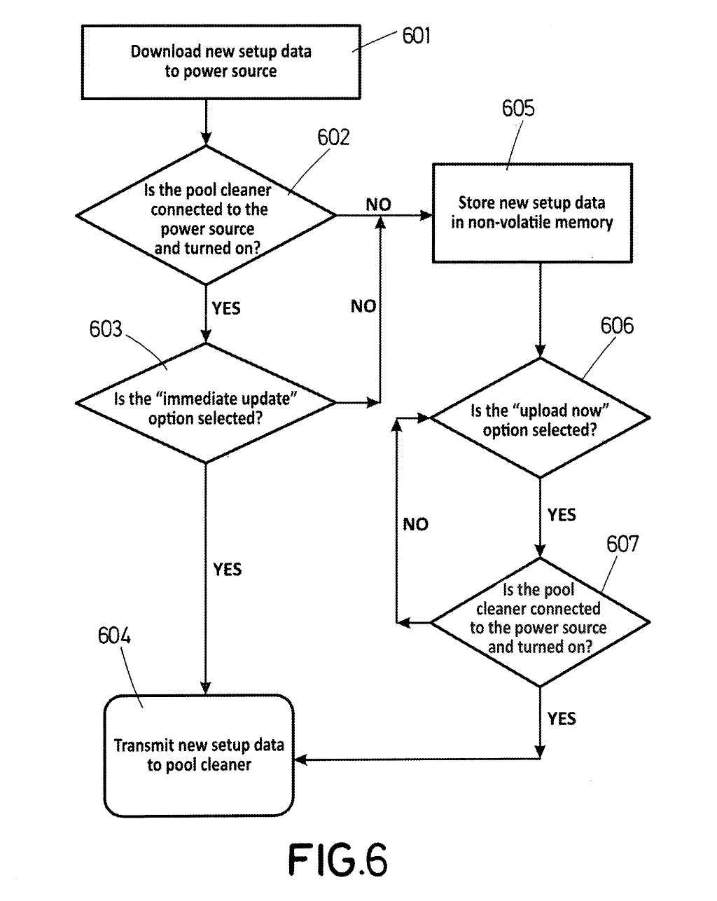

One example of such an embodiment is illustrated in FIG. 6. In a first step 601 the user uploads, from a user terminal 4 or other suitable means, the relevant setup data to the power source 1. The power source verifies 602 if the pool cleaner 3 is available for uploading the setup data via the power cable 2 and, if it is, the power source 1 verifies 603 if an “immediate update” option has been selected. If the outcome of these two verifications is positive, the power source 1 transmits 604 the new setup data to the pool cleaner 3, thereby updating the setup of the onboard control system 350 thereof. If the outcome of one of the two verifications is negative, the new setup data are stored 605 in the memory 101 of the power source 1.

At this stage, the user can then trigger an upload of the setup data to the pool cleaner 3 by selecting an “upload now” option. While this option is selected 606, the power source 1 monitors 607 the connection to the pool cleaner 3 to detect when the pool cleaner 3 is connected to the power source 1 and turned on and, once turned on, transmits the setup data to the pool cleaner 3, thereby updating the onboard control system 350 thereof.

FIG. 7 provides one example embodiment of setup data that can be transferred to the pool cleaner (e.g., at step 604 of FIG. 6). At a high-level, the setup data depicted in FIG. 7 is a program for segmented or sectional pool cleaning. The program utilizes outputs from sensors, such as one or more gyroscopic sensors (or other such tilt sensors), one or more accelerometers, and/or one or more proximity sensors, to determine a segment of a pool in which the pool cleaner is disposed. Then, the program causes the onboard control system to control motors included in the pool cleaner (e.g., motors 361 and 362) to either cause the pool cleaner to remain in a particular segment (e.g., the deep end) or move to a new segment.

More specifically, when the pool cleaner is powered on and inserted into the pool, the setup data causes the pool cleaner peripherals to initialize at 702 so that the onboard control system can compute the current pitch, roll, and yaw of the pool cleaner at 704. For example, an accelerometer and gyroscope may initialize at 702 so that the onboard control system can compute the current pitch, roll, and yaw at 704. Based on these computations, the onboard control system determines, at 706, whether the pool cleaner is on a flat surface or a sloped surface. After making this determination at 706, the onboard control system establishes a “cleaning history.” Generally, the segmented pool cleaning program causes the pool cleaner to clean the pool in a continual pattern of segments. Thus, establishing a cleaning history sets a starting point within this pattern. For example, if a pool has a deep end, shallow end and a sloped section extending therebetween, the pattern may be a loop of the following pattern: clean the shallow end, clean the sloped section, clean the deep end, clean the sloped section, clean the shallow end, etc., so that the pool cleaner continually covers the entire pool in a segmented manner. However, on the other hand, not all pools include deep ends and shallow ends separated by a slope. For example, some pools may be completely flat or continually sloped.

To accommodate various pools, if the onboard control system detects a flat surface at 706 (e.g., an accelerometer indicates that the pool cleaner is resting on a flat surface), the onboard control system, based on instructions from the segmented pool cleaning setup data, assumes, at 708, that a pool is completely flat and sets the history sets the history to shallow at times T1, T2, and T3. Then, the onboard control system sets the current segment to shallow at 710. On the other hand, if the onboard control system detects a sloped surface at 706 (e.g., the accelerometer indicates that the pool cleaner is resting on an inclined or declined, non-wall surface) the onboard control system, based on instructions from the segmented pool cleaning setup data, assumes, at 712, that the pool has a deep end and a shallow end separated by a sloped section and sets the history to slope, deep, and slope at times T1, T2, and T3, respectively. In some pools, the deep section and shallow section may have a slight slope. Consequently, in at least some embodiments, the onboard control system detects a sloped surface at 706 when the slope is between 15-25 degrees. Otherwise, the onboard control system detects a wall (greater than 25 degrees) or a flat section (less than 15 degrees). Regardless of how the onboard control system detects a sloped surface at 706, once a sloped surface is detected, the onboard control system sets the current segment to slope at 714. That is, the onboard control system selects a starting point within the pattern mentioned above.

After establishing the cleaning history and current segment at 708 and 710 or 712 and 714, the program causes the onboard control system to begin to execute a cleaner movement while monitoring sensor outputs (e.g., outputs from a gyroscope and/or accelerometer, or any tilt sensor and/or proximity sensor) at 720. The cleaner movement operates in the segment of the pool in which the pool cleaner was initially inserted. For example, if the pool cleaner is initially dropped into the deep end of the pool, the first cleaner movement will execute in the deep end. The cleaner movement may be any cleaner movement pattern now known or developed hereafter, whether sensor-based (e.g., automatic), timer based, and/or other any other such movement, such as wall-to-wall cleaning, follow-the-wall cleaning, radial cleaning patterns, etc. In at least some embodiments, the onboard control system may begin to execute a cleaner movement that is specific to the particular pool segment in which the onboard control system believes the pool cleaner is disposed (e.g., a slope-specific cleaning program if the onboard control system determines, at 714 that the pool cleaner is disposed in a sloped surface). The onboard control system also initializes a timer when the cleaner movement begins at 720.

At 722, the onboard control system determines, based on the sensor outputs, whether the pool cleaner is exiting its current segment. For example, if the pool cleaner is detecting that the pool cleaner is on a sloped surface, the pool cleaner may detect an exit when the slope no longer exists or changes (positively or negatively) by a predetermined amount (e.g., 15 degrees or more, 30 degrees or more, 45 degrees or more, etc.). Alternatively, if the pool cleaner is detecting that the pool cleaner is on a flat surface, the pool cleaner may detect an exit when the pool cleaner detects a sloped surface. Still further, in some embodiments, the onboard control system may determine that the pool cleaner is exiting its current segment when the pool cleaner traverses a predetermined percentage of a major dimension of a pool. For example, if a pool is sloped from one end to the other with a relatively constant slope, the onboard control system may use a predetermined length of the pool to delineate segments of the pool (e.g., the pool may be divided into three equally sized segments that each span one-third of the overall length of the pool). In these embodiments, it may be necessary to map the pool prior to implementing segmented cleaning (e.g., with data input by a user and/or via sensor-based mapping).

In at least some embodiments, a pool cleaner can exit its current segment by moving (e.g., driving) between flat and sloped sections (a “segment-to-segment” or “non-wall” exit) or by driving off of/onto a wall (a “wall exit”). The onboard control system monitors sensor outputs at 722 to distinguish between these two types of exits. That is, the onboard control system determines if the pool cleaner is: (1) moving from a flat or sloped surface onto a different flat or sloped surface; or (2) moving between a flat or sloped surface and a wall. Put still another way, orientation determinations made in view of sensor outputs from accelerometers, gyroscopic sensors, and/or other sensors may be able to distinguish between wall exits and non-wall exits (e.g., the onboard control system may determine if pitch and roll readings are indicative of cleaner moving from a flat surface to a sloped surface, a flat surface to a wall, a sloped surface to a flat surface, a sloped surface to a wall, or any other such “exit”).

If, at 722, the onboard control system determines that the pool cleaner has not exited the current segment, the onboard control system determines, at 724, whether the current segment timeout has been reached. In some embodiments, the timeout is strictly time-based. Alternatively, the timeout may be based on a timer and/or sensor feedback related to the cleanliness of a pool section. That is, the value (e.g., length) of the timeout may be a predetermined setting or a setting that is dynamically determined based on a size of a particular pool segment, a time of year, user inputs, or any other factors, including cleanliness of a pool segment, which may be determined based on sensor feedback, for example, in the manner discussed in U.S. Pat. No. 9,506,262, which is hereby incorporated by reference in its entirety. If the timeout has not been reached (and the pool cleaner has not exited its current segment), the onboard control system continues to execute the cleaning movement initiated at 720 (while continuing to determine if the pool cleaning is exiting the segment and if the segment timeout has been reached at 722 and 724, respectively). Put plainly, if the pool cleaner has not spent too much time in a particular pool segment (i.e., if the pool cleaner is in a segment for a period of time less than the timeout) and/or the particular pool segment is not yet clean, the pool cleaner will continue to clean that segment.

If, instead, the segment timeout is determined to have been reached at 724, the segmented program setup data causes the onboard control system to determine that the pool cleaner should exit the current segment and move to a new segment. That is, if the pool cleaner has spent too much time in a particular pool section/segment, the onboard control system determines, at 724, that it is time to leave this section/segment and, at 726, causes the pool cleaner to move to a next section/segment of the pool. In at least some embodiments, moving to a next segment may be effectuated by searching for a slope in the pool, causing the one or more motors to drive towards a slope pre-identified in the setup data, or causing the one or more motors to drive towards a previously identified slope (e.g., a slope identified unintentionally at 722). This may ensure that the pool cleaner does not get stuck in a certain segment (e.g., the shallow end). In these embodiments, the next segment may be determined based on the overall pattern of shallow-slope-deep-slope-shallow-slope-deep, and the method for determining the next segment is described in further detail below in connection with steps 740, 745, and 750. However, in other embodiments, other patterns may be used and, thus, the exit may involve searching for other features of the pool. For example, a pattern may incorporate wall cleaning segments and to enter/exit these segments, the pool cleaner may search for a transition between a wall and a sloped or flat surface (e.g., a wall exit).

Now turning back to 722, if the onboard control system determines at 722 that the pool cleaner has exited the current segment on its own (e.g., by naturally or unintentionally beginning to drive into a new segment or beginning to climb a wall while executing the cleaner movement from 720), the onboard control system checks the timeout at 732 to determine whether the segment timeout of the current segment has been reached. That is, at 732, the onboard control system determines whether the pool cleaner should be allowed to leave the current section/segment. For example, if the pool cleaner is executing a wall-to-wall cleaning pattern in the shallow end and unintentionally moves onto the sloped section of the pool, the onboard control system may determine if the pool cleaner should return to the shallow end or simply continue its movement and begin cleaning the sloped section. In at least some embodiments, the timeout is enforced strictly at 724 but enforced with at least some leniency at 732. For example, if the timer imitated at 720 has reached a predetermined percentage of the timeout, such as 75%, 80%, 85%, etc., this may be sufficient to consider the timeout reached at 732. This leniency may ensure that a pool cleaner is not sent back into a segment when the pool cleaner has nearly completed cleaning a specific section. However, in other embodiments, the timeout may be strictly enforced at 732.

Regardless of how the timeout is enforced at 732, if a determination of “no” is made at 732, the onboard control system issues instructions to the motors that cause the pool cleaner to return to the shallow end at 734. Notably, since the pool cleaner will return to its current segment, the onboard control system need not determine if the pool cleaner is exiting its current segment via a wall or a sloped section. That is, the onboard control will cause the pool cleaner to return to its current section regardless of whether the pool cleaner is exiting the current segment via a wall or by moving into a next segment.

In some embodiments, the onboard control system may constantly monitor the timer to determine if a timeout occurs during a return to the current segment (e.g., there may be a feedback loop between 734 and 732) and, if the timeout has been satisfied, the pool cleaner may abandon the return and simply proceed to the next segment (e.g., in accordance with steps 736 and 726). Alternatively, in other embodiments, the timer may be temporarily paused, during an unintentional exit and return executed at 722, 732, and 734. This pause may ensure that the pool cleaner does not satisfy the timeout threshold for a particular segment while the cleaner is actually disposed in other sections (and not cleaning the segment to which the timeout applies). That is, the pause in the timeout timer may ensure that the pool cleaner spends a designated amount of time in particular section, regardless of temporary exits.

On the other hand, if the timeout has been reached and the onboard control system is going to allow the pool cleaner to exit the current segment, the onboard control system determines if the pool cleaner is exiting the current segment by driving into an adjacent section/segment of the pool or by moving up a wall. This determination is made at 736. In at least some embodiments, if the pool cleaner is not moving up a wall, the pool cleaner may simply continue its movement into the next section/segment of the pool in accordance with steps 740, 745, and 750, which are described in detail below. If, instead, the pool cleaner is determined to be moving up a wall at 738, the onboard control system may, in at least some embodiments (e.g., embodiments utilizing the pattern of shallow-slope-deep-slope-shallow-slope-deep), issues instructions, at 726, to the motors that cause the pool cleaner to move to the next segment. Alternatively, if the pool cleaner is utilizing a cleaning pattern with wall cleaning segments, the pool cleaner may allow a pool cleaner to continue onto a wall until the pool cleaner determines if the wall is the proper next segment. In fact, in embodiments with wall cleaning segments, the onboard control system may not need to determine if the pool cleaner is exiting a wall at 736 (and, instead, may proceed directly from 732 to 726 (and then to 740, etc.)).

Regardless of why the pool cleaner exits its current section/segment and moves into a next section/segment of the pool, the onboard control system analyzes sensor outputs as the pool cleaner enters the next segment of the pool. Based on this analysis, the onboard control system determines, at 740, if the segment that the pool cleaner is exiting was correctly identified during initialization. For example, if the pool cleaner is exiting a segment identified as a shallow end and the onboard control system detects an upwards, non-wall slope, the onboard control system may determine that the previous segment was incorrectly identified (since the shallow end is typically only adjacent to a downwards slope). As another example, if the pool cleaner is exiting a segment identified as a deep end and the onboard control system detects a downwards, non-wall slope, the onboard control system may determine that the previous segment was incorrectly identified (since the deep end is typically only adjacent to an upwards slope). As still another example, if the pool cleaner is exiting a segment identified as part of a completely flat pool and the onboard control system detects a non-wall slope, the onboard control system may determine that the previous segment was incorrectly identified.

If an error is found at 740 (i.e., if the previous segment was not correctly identified), the cleaning history set during initialization is also likely to be incorrect. Thus, if an error is found at 740, the cleaning history is corrected at 745. Using the same examples laid out above, if the onboard control system determines that a segment identified as a shallow end is actually a deep end, the three-time period cleaning history (with the third entry showing the segment which the cleaner is exiting) may be changed from “deep-slope-shallow” to “shallow-slope-deep.” Similarly, if the onboard control system determines that a segment identified as a deep end is actually a shallow end, the three-time period cleaning history may be changed from “shallow-slope-deep” to “deep-slope-shallow.” In the last example laid out above (where a pool with a slope was misidentified as a completely flat pool), the history “shallow-shallow-shallow” may be changed to “shallow-slope-deep” or “deep-slope-shallow” depending on the non-wall slope now detected by the pool cleaner (with an incline indicating that the most recent segment was the deep end and decline indicating that the most recent segment was the shallow end). That is, in the last example, the onboard control system determines that the pool is not completely flat and adopts the cleaning pattern for a pool with a deep end and a shallow end that are separated by a sloped section (as discussed above, the pattern causes the pool cleaner to clean the entire pool in a segmented manner).

Once the cleaning history and previous segment are corrected or confirmed to be correct, the onboard control system can determine the next segment to clean at 750 and set the next segment as the current segment at 755. At 750, some example determinations, determined based on the pattern discussed above, are shown. First, if the cleaning history shows T2=slope and T3=shallow, these data entries are each moved back in the history (to T1 and T2, respectively) and the current segment is set to slope (“T3=slope”). Second, if the cleaning history shows T2=slope and T3=deep, these data entries are each moved back in the history (to T1 and T2, respectively) and the current segment is set to slope (“T3=slope”). Third, if the cleaning history shows T2=shallow and T3=slope, these data entries are each moved back in the history (to T1 and T2, respectively) and the current segment is set to deep (“T3=deep”). Fourth, if the cleaning history shows T2=deep and T3=slope, these data entries are each moved back in the history (to T1 and T2, respectively) and the current segment is set to shallow (“T3=shallow”). Notably, although not shown in the flow chart of FIG. 7, in at least some embodiments, the segmented cleaning setup data may cause the onboard control system to determine whether the current segment and cleaning history are correct (via the steps shown at 740, 745) during temporary exits (e.g., as the pool cleaner returns to a current segment at 734). Additionally or alternatively, in some embodiments, the onboard control system may only determine whether the current segment and cleaning history are correct (via the steps shown at 740, 745), a single time (and may operate with the corrected or confirmed cleaning history for the remainder of a cleaning session).

In this text, the term “comprises” and its derivations (such as “comprising”, etc.) should not be understood in an excluding sense, that is, these terms should not be interpreted as excluding the possibility that what is described and defined may include further elements, steps, etc.

The invention is obviously not limited to the specific embodiment(s) described herein, but also encompasses any variations that may be considered by any person skilled in the art (for example, as regards the choice of materials, dimensions, components, configuration, etc.), within the general scope of the invention as defined in the claims.

1. An automatic pool cleaner comprising:
one or more onboard sensors configured to detect an orientation of the automatic pool cleaner with respect to a surface of a pool; and
an onboard control system configured to:
determine, based on outputs from the one or more onboard sensors, that the automatic pool cleaner is disposed in a particular segment of the pool; and
control movement of the automatic pool cleaner along the surface of the pool based on the determining so that the automatic pool cleaner spends a predetermined amount of time in the particular segment of the pool.

2. The automatic pool cleaner of claim 1, wherein the predetermined amount of time is determined based on a user input.

3. The automatic pool cleaner of claim 1, wherein the particular segment is selected from a group including: a deep section of the pool, a shallow section of the pool, a sloped section extending between the shallow section and the deep section, and a wall section.

4. The automatic pool cleaner of claim 1, wherein in controlling the movement of the automatic pool cleaner, the onboard control system is configured to:
cause the automatic pool cleaner to exit the particular segment and move to a next segment after the predetermined amount of time.

5. The automatic pool cleaner of claim 4, wherein:
the particular segment is selected from a group including: a deep section of the pool, a shallow section of the pool, or a sloped section extending between the shallow section and the deep section; and
the next segment is a different segment from the group that is adjacent to the particular segment.

6. The automatic pool cleaner of claim 1, wherein in controlling the movement of the automatic pool cleaner, the onboard control system is configured to:
cause the automatic pool cleaner to return to the particular segment if the automatic pool cleaner begins to exit the current segment before the predetermined amount of time.

7. The automatic pool cleaner of claim 6, wherein in controlling the movement of the automatic pool cleaner, the onboard control system is configured to:
allow the automatic pool cleaner to continue exiting the particular segment if the predetermined amount of time expires during the exit.

8. The automatic pool cleaner of claim 7, wherein in allowing the automatic pool cleaner to continue exiting the particular segment, the onboard control system is configured to:
upon detecting that the exit is a wall exit, cause the automatic pool cleaner to move from the wall exit to a segment-to-segment exit.

9. The automatic pool cleaner of claim 1, wherein the one or more onboard sensors measure tilt angles about at least two of: a pitch axis, a roll axis, and a yaw axis, to detect the orientation of the automatic pool cleaner.

10. The automatic pool cleaner of claim 9, wherein the one or more onboard sensors comprise at least one accelerometer or tilt sensor.

11. A method for operating an automatic pool cleaner comprising:
determining, based on outputs from one or more onboard sensors configured to detect an orientation of the automatic pool cleaner with respect to a surface of a pool, that the automatic pool cleaner is disposed in a particular segment of the pool; and
controlling movement of the automatic pool cleaner along the surface of the pool based on the determining so that the automatic pool cleaner spends a predetermined amount of time in the particular segment of the pool.

12. The method of claim 11, wherein the predetermined amount of time is determined based on a user input.

13. The method of claim 11, wherein the particular segment is selected from a group including: a deep section of the pool, a shallow section of the pool, a sloped section extending between the shallow section and the deep section, and a wall section.

14. The method of claim 11, wherein the controlling further comprises:
causing the automatic pool cleaner to exit the particular segment and move to a next segment after the predetermined amount of time.

15. The method of claim 14, wherein:
the particular segment is selected from a group including: a deep section of the pool, a shallow section of the pool, or a sloped section extending between the shallow section and the deep section; and
the next segment is a different segment from the group that is adjacent to the particular segment.

16. The method of claim 11, wherein the controlling further comprises:
causing the automatic pool cleaner to return to the particular segment if the automatic pool cleaner begins to exit the current segment before the predetermined amount of time.

17. The method of claim 16, wherein the controlling further comprises:
allow the automatic pool cleaner to continue exiting the particular segment if the predetermined amount of time expires during the exit.

18. The method of claim 11, wherein the one or more onboard sensors measure tilt angles about at least two of: a pitch axis, a roll axis, and a yaw axis, to detect the orientation of the automatic pool cleaner

19. The method of claim 18, wherein the one or more onboard sensors comprise at least one accelerometer or tilt sensor.

20. The method of claim 11, wherein the determining and the controlling is performed by an onboard control system included in the automatic pool cleaner.
